(19) United States
(12) Patent Application Publication
(10) Pub. No.: US 2012/0255983 A1
(43) Pub. Date: Oct. 11, 2012

(54) Backpack Adapted for Attachment to Bicycle

(76) Inventor: Michael Semone, Middlesex, NJ (US)

(21) Appl. No.: 13/440,343

(22) Filed: Apr. 5, 2012

Related U.S. Application Data
(60) Provisional application No. 61/472,479, filed on Apr. 6, 2011.

(51) Int. Cl. B62J 11/00; A45F 3/04

(52) U.S. Cl. 224/585; 224/419

(57) ABSTRACT

A fully-adjustable device that, when integrated into a backpack, etc., will allow the backpack to be both comfortably worn on the user's back and also hook to the rear rack of a bicycle in the manner of a pannier or saddlebag. By creating a device that allows quick and easy transition between carrying on-person and on-bicycle, while also providing the aesthetics and comfort-level of a typical backpack, the present invention combines the best features of the two carrying methods in a new and novel way.

### CROSS-REFERENCE TO RELATED APPLICATIONS

The present application claims the benefit of the filing date of U.S. Provisional Patent Application Ser. No. 61/472,479 filed by the present inventor on Apr. 6, 2011. ON The aforementioned provisional patent application is hereby incorporated by reference in its entirety.

### STATEMENT REGARDING FEDERALLY SPONSORED RESEARCH OR DEVELOPMENT

None.

### BACKGROUND OF THE INVENTION

1. Field Of The Invention

The present invention relates to backpacks and bicycle saddlebags or panniers and more particularly to a backpack adapted for attachment to a bicycle.

2. Brief Description Of The Related Art

While some users like riding with backpacks on their backs, many find that they bags are uncomfortable and cause unnecessary sweating. Some users get around this by using panniers (Ortlieb and Jandd are two major companies selling these). The problem that they find with panniers, however, is that they are often not easily removable/installable, nor are they easy to carry when not riding. A major reason against the use of panniers as determined through interviews is risk of theft: Imagine you're commuting to work, class, etc. via bicycle and want to stop at a store during your commute, say for breakfast. If you're using a pannier, you essentially have two options. First, you can leave the bags on your bike and hope for the best, or, you can remove them and carry them into the store. Both are unfavorable.

The general trend is that companies making panniers update them to include carry straps similar to that of a messenger bag. I have taken a backpack (stock) and turned it into a bicycle pannier The three exemplary prior art products include the following: Ortlieb Vario Commuter Backpack Pannier, Arkell Switchback and Timbuk2 Shift Pannier Messenger.

### SUMMARY OF THE INVENTION

The present invention is a fully-adjustable device that, when integrated into a backpack, etc., will allow the bag to be both comfortably worn on the user's back and also hook to the rear rack of a bicycle in the manner of a pannier or saddlebag. By creating a device that allows quick and easy transition between carrying on-person and on-bicycle, while also providing the aesthetics and comfort-level of a typical backpack, the present invention combines the best features of the two carrying methods in a way that no other product currently on the market does.

In a preferred embodiment, the present invention is a plate assembly having a rigid plate, a pad, an upper hook assembly and a lower hook assembly. The rigid plate is formed of a rigid material having a first opening for receiving an upper hook and a second opening for receiving a lower hook. The pad has a back surface attached to the rigid plate and a front surface facing away from the rigid plate. The pad may be attached to the rigid plate is any known manner, including but not limited to being glued, sown, screwed or bolted. The pad having openings corresponding to the first and second openings in the rigid plate. The upper hook assembly is mounted to the rigid plate and has an upper hook and a pin. The pin is mounted to the rigid plate and the upper hook is rotatably mounted on the pin to have a first position in which the hook projects from the front surface of the pad and a second position in which the hook does not project from the front surface of the pad. The lower hook assembly has an elastic member connected to the rigid plate and a lower hook connected to the elastic member. The apparatus also may have a backpack connected the plate assembly, wherein the rigid plate is positioned between the pad and the backpack. The rigid plate further may have a plurality of vent openings, first and second openings through which the elastic member passes and a plurality of holes for attaching the elastic member to the rigid plate. The pad similarly may have first and second openings through which the elastic member passes and/or vent openings.

The plate assembly may have a second upper hook assembly mounted to the rigid plate. The second upper hook assembly has a second upper hook and a second pin, wherein the second pin is mounted to the rigid plate and the second upper hook is rotatably mounted on the second pin to have a first position in which the second hook projects from the front surface of the pad and a second position in which the second hook does not project from the front surface of the pad. The pins in the first and second hook assemblies each may be comprises of a back plate attachment member attached to the back plate and a rod member on which the upper hook is rotatably mounted. The back plate attachment member and the rod member may be of unitary construction or may be connected to one another, such as by welding. Each the pin may have a plate portion having a plurality of holes for receiving bolts and a rod portion.

In another embodiment, the present invention is an apparatus comprised of a plate assembly. The plate assembly has a rigid back plate, a pad, first and second upper hook assemblies and a lower hook assembly. The rigid back plate is formed from a rigid material having first and second openings for receiving first and second upper hooks. The pad has a back surface attached to the rigid plate and a front surface facing away from the rigid plate, the pad having openings corresponding to the first and second openings in the rigid plate. The first and second upper hook assemblies each are mounted to the rigid plate. Each of the first and second upper hook assemblies have an upper hook and a pair of half pins, wherein each the half pin is mounted to the rigid plate and the upper hook is rotatably mounted on the pair of half pins to have a first position in which the hook projects from the front surface of the pad and a second position in which the hook does not project from the front surface of the pad. The lower hook assembly has an elastic member connected to the rigid plate and a lower hook connected to the elastic member.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a perspective view of a combined backpack and rack assembly in accordance with a preferred embodiment of the present invention.

FIG. 2 is a cross-sectional view of a rack assembly in accordance with a preferred embodiment of the present invention.

FIG. 3A is a front view of a rigid plate of a rack assembly in accordance with a preferred embodiment of the present invention.

FIG. 3B is a side view of a rigid plate of a plate assembly in accordance with a preferred embodiment of the present invention.

FIG. 4A is a front view of a foam back pad of a rack assembly in accordance with a preferred embodiment of the present invention.

FIG. 4B is a side view of a foam back pad of a rack assembly in accordance with a preferred embodiment of the present invention.

FIG. 5A is a side view of a top or upper hook of a rack assembly in a preferred embodiment of the present invention.

FIG. 5B is a front view of a top or upper hook of a rack assembly in a preferred embodiment of the present invention.

FIG. 5C is a top view of a top or upper hook of a rack assembly in a preferred embodiment of the present invention.

FIG. 5D is a perspective view of a top or upper hook of a rack assembly in a preferred embodiment of the present invention.

FIG. 6A is a side view of a hinge pin of a rack assembly in a preferred embodiment of the present invention.

FIG. 6B is a front view of a hinge pin of a rack assembly in a preferred embodiment of the present invention.

FIG. 6C is a top view of a hinge pin of a rack assembly in a preferred embodiment of the present invention.

FIG. 6D is a perspective view of a hinge pin of a rack assembly in a preferred embodiment of the present invention.

FIG. 7A is a rear perspective view of a top or upper hook assembly of a preferred embodiment of the present invention.

FIG. 7B is a front perspective view of a top or upper hook assembly of a preferred embodiment of the present invention.

FIG. 8A is a rear view of a top or upper hook assembly of a preferred embodiment of the present invention.

FIG. 8B is a front view of a top or upper hook assembly of a preferred embodiment of the present invention.

FIG. 9 is a front view of a plate assembly in accordance with a preferred embodiment of the present invention.

FIG. 10 is a side view of a lower hook of a rack assembly in accordance with a preferred embodiment of the present invention.

FIG. 11A is a side view of a second embodiment of a top or upper hook of a rack assembly in a preferred embodiment of the present invention.

FIG. 11B is a front view of a second embodiment of a top or upper hook of a rack assembly in a preferred embodiment of the present invention.

FIG. 11C is a top view of a second embodiment of a top or upper hook of a rack assembly in a preferred embodiment of the present invention.

FIG. 11D is a perspective view of a second embodiment of a hook of a rack assembly in a preferred embodiment of the present invention.

FIG. 12 is a front view of a second embodiment of a rigid plate of a rack assembly in accordance with a preferred embodiment of the present invention.

### DETAILED DESCRIPTION OF THE PREFERRED EMBODIMENTS

In a preferred embodiment, the present invention is plate or rack assembly 200 comprised of a rigid plate 300 (for example, polycarbonate, ⅛″ thick), two hinged-hooks 500 for hooking onto the top section of a bicycle rack, and an elastic strap 910 connected to another hook 920 for securing the device to a lower point on the rack/bike.

When in “backpack” mode, the device is almost completely flat on the exposed side. At the shoulder blades, the only protrusions are eight (8) #4-40 screw heads (could also be larger screws, i.e. #6-32, or smaller screws), which are easily covered by a foam pad 400. The foam pad 400 may have any of a variety of configurations, for example, a body 410 with openings 420 to accommodate the upper hooks 500 and an opening 430 to accommodate the lower hood 920. The foam pad additional may have other openings such as vents or holes to attachment means such as bolts or screws the pass through. Nearer the bottom section, the greatest protrusion is a 0.25″ elastic bungee cord 910 that is placed such that it will minimally affect carrying comfort. Again, this interference is reduced to none when a 0.25″ foam pad 400 is placed over this face of the device. Since overall thickness was minimized by design, the interior exposed face (the side that would be inside the bag) has a maximum of 0.25″ protruding parts, thus maximizing both comfort and interior volume.

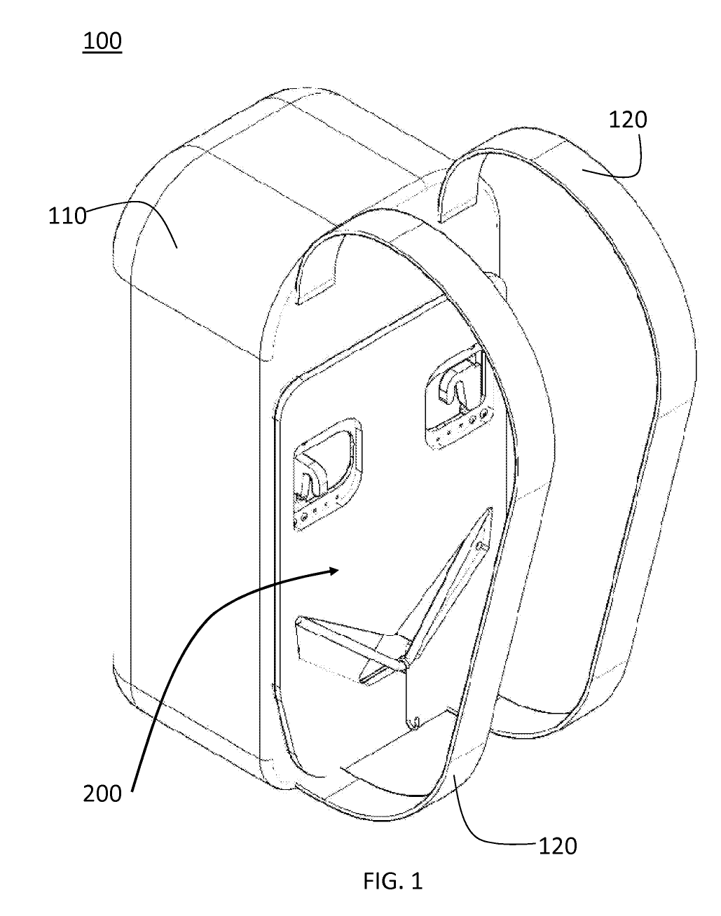

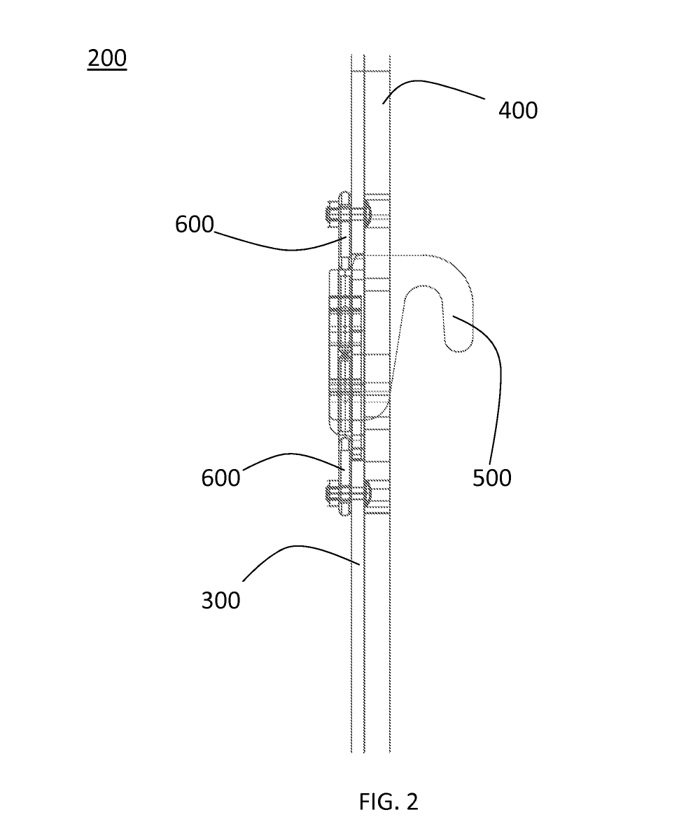

The rigid plate 300, as in any pannier, is meant to ensure that the contents of the bag do not bulge and interfere with the rotation of the tires. The exterior shape of the plate is based on a taller and thinner cycling/climbing-style backpack 110 (such as ones by Osprey and GoLite) for functionality and aesthetic reasons. The backpack 110, of course, has shoulder or other carrying straps 120 as shown in FIG. 1. The taller style allows for similar interior volume with more heel clearance when cycling, and it also provides a sleek look that panniers, especially those that convert to carried bags, just do not provide.

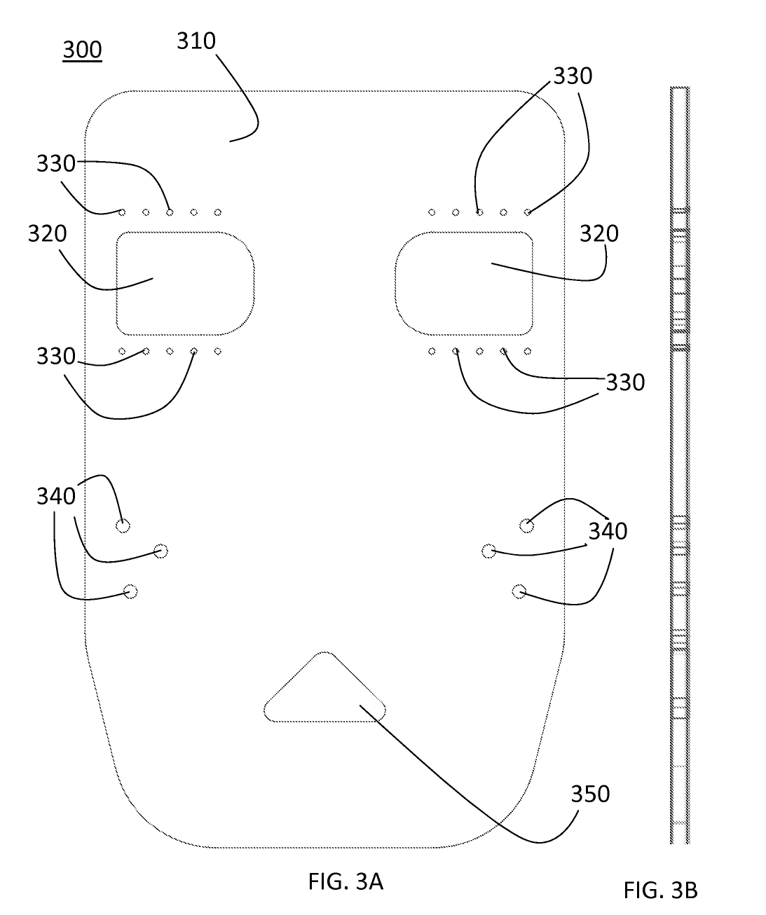

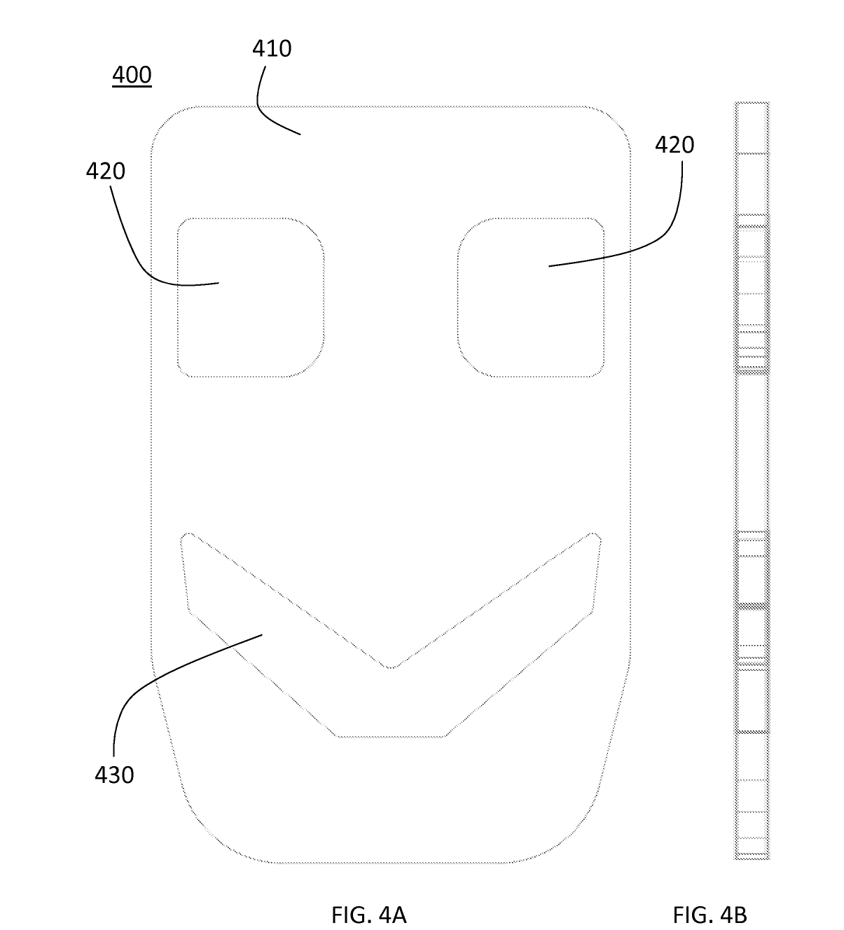

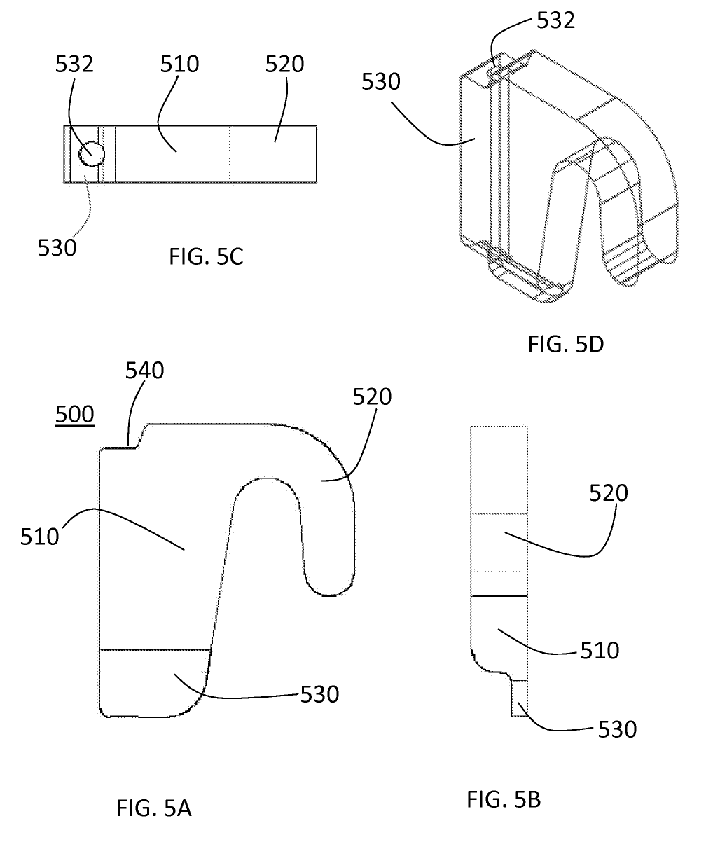

The plate 300, shown in FIGS. 3A and 3B, has a body 310 having two large holes 320 near the top to allow clearance for the hooks 500 and therefore minimize the thickness of the assembled device. The top hooks 500, shown in FIGS. 5A-5D, have a body 510 and are shaped with a hook part 520 that incorporates an extra 0.25″ clearance to anticipate that a foam cover may be placed permanently in the bag, an interior hole 532 for a custom hinge-pin 600, and two cut-away sections 530, 540. The cut-away section 540 at the top of the hinge 530 keeps the hook 520 from wobbling around when on the bicycle, and the one at the bottom 530 stores the hook in the flattened position for carrying.

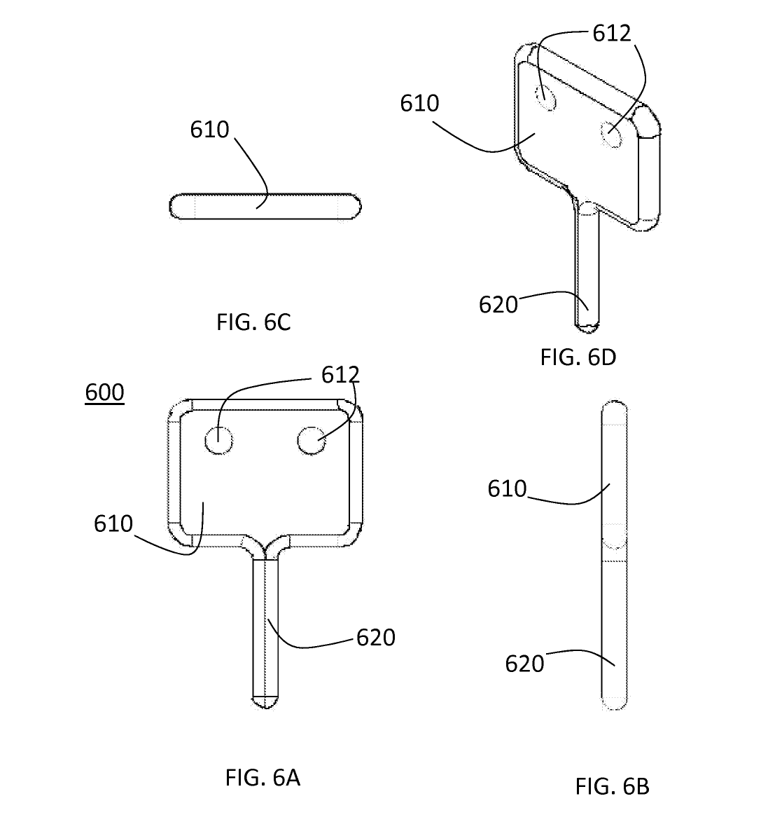

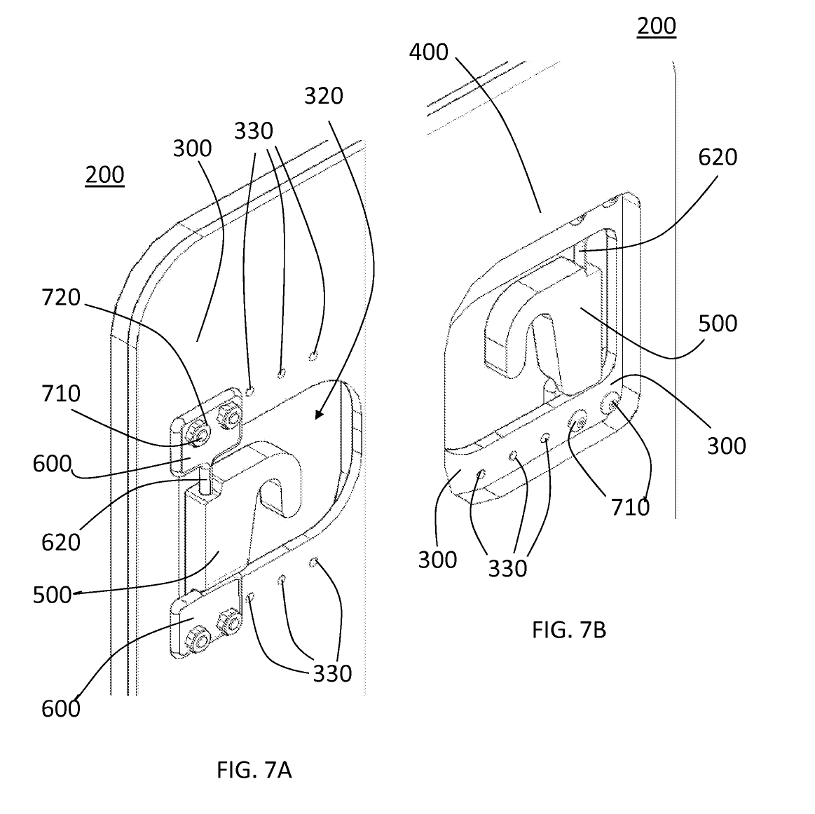

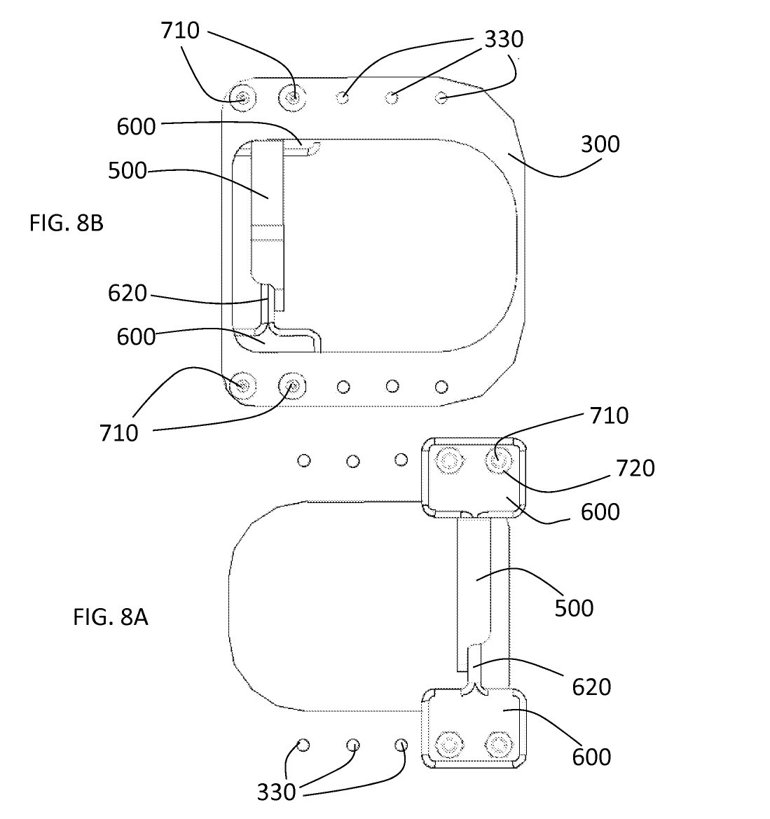

The pins 600 on which the top hooks 500 rotate are halved to aide assembly. Each half pin 600 is designed preferably as a single cut-away of 0.125″ 304 or 316 Stainless Steel shaped to include a wide connection tab 610 and a 0.125″ extended pin section 620. Each half-pin 600 is screwed to the interior face (bag-side) of the plate 300 by, for example, bolts 710 placed through holes 612 in the tab 610 and holes 330 in the plate 300 and secured with nuts 720, with the hooks fitted in sequence. A preferred embodiment uses #4-40 Truss-Head machine screws (extra-wide pan head) to reduce the need for washers and Nylock low-profile locking nuts for resistance to vibration. Other attachment means such as screws, studs or glue may be used to attached or secure the half pins 600 to the back plate 300. The half pins shown in FIG. 6 are of unitary construction, but other embodiments such as a pin welded to or otherwise connected to a flat plate will be apparent to those of skill in the art.

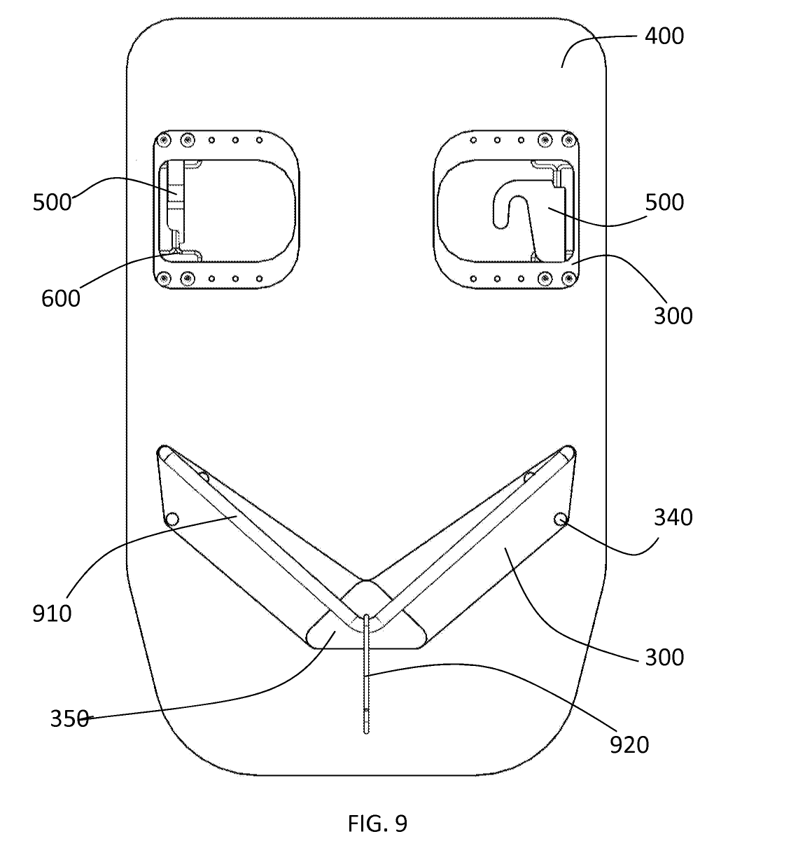

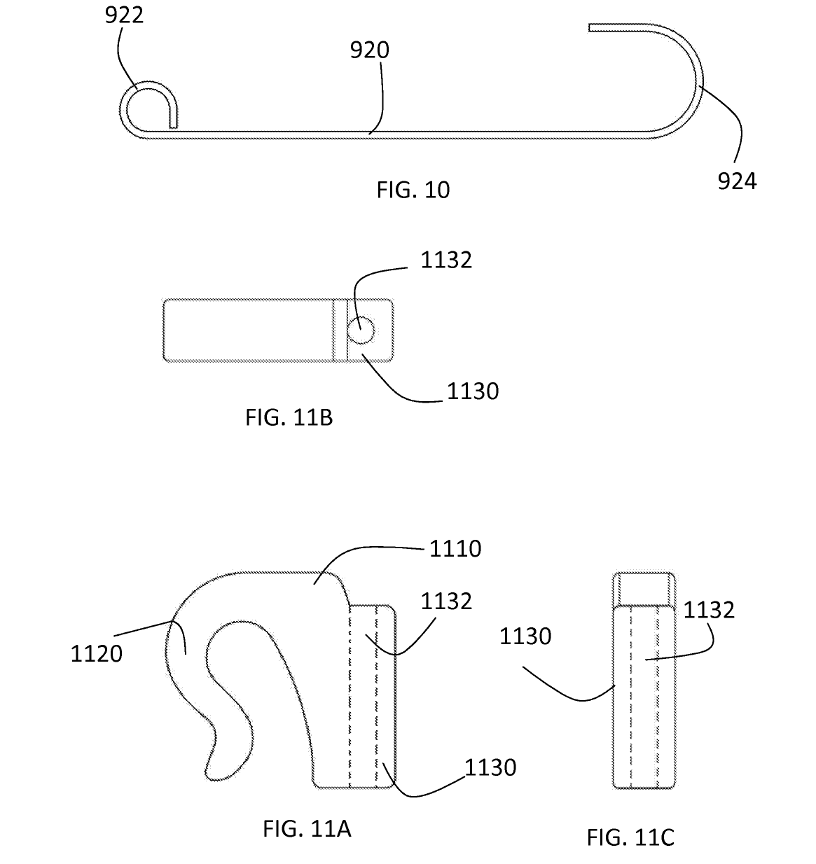

The lower half of the plate 300 includes holes 340 and spacing for an elastic bungee cord 910 or other elastic strap to be attached to the plate 300 and can be fitted, for example, with a slender bent-rod hook 920. As shown in FIG. 9, the bent-rod 920 may hook may have a ring portion 922 or other means for attaching the lower hook 920 to the bungee cord 910 and a hook portion 924. The triangular hole 350 in the plate 300 is provided so that the user can store this lower hook 920 on the interior of the bag when carrying the assembly on-person. The back plate also may have additional openings through which the bungie cord may pass and vents. The lower hook 920 is designed to minimize the profile of both the interior and exterior faces during storage. A 0.060″ stainless steel rod is bent to fit around the elastic, bent at the opposite end to make the hook shape, and may be bent twice more near the center to provide that the hook sits flat on both faces during storage.

Adjustability is designed into the entire device: At the top, multiple connection holes 330 allow the user to customize the position of the hooks 500 to their liking. At the bottom, the elastic strap 910 can be adjusted for different rear rack heights, and the lower hook 920 is free to move side-to-side along the elastic, thus providing a third level of adjustability for lower-hook placement.

An alternative embodiment for an upper hook of the present invention is shown in

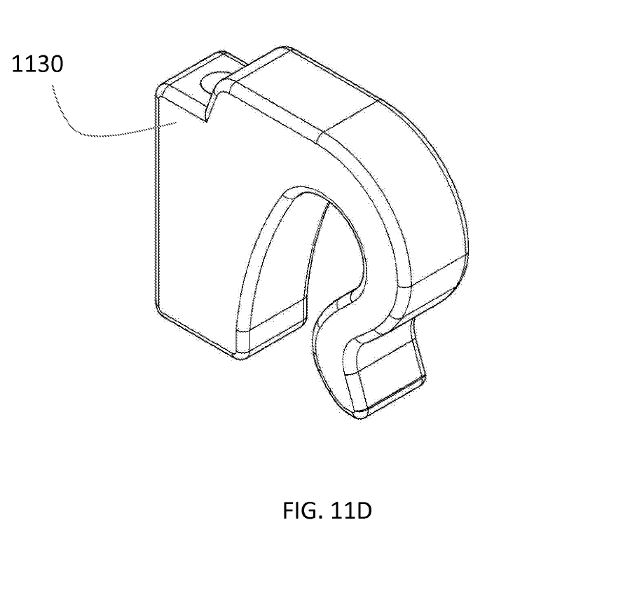

FIGS. 11A-11D. The alternative upper hook has a body 1110, a hook portion 1120 and a tab 1130 through which there is a hole 1132 for securing the hook to a half pin 600.

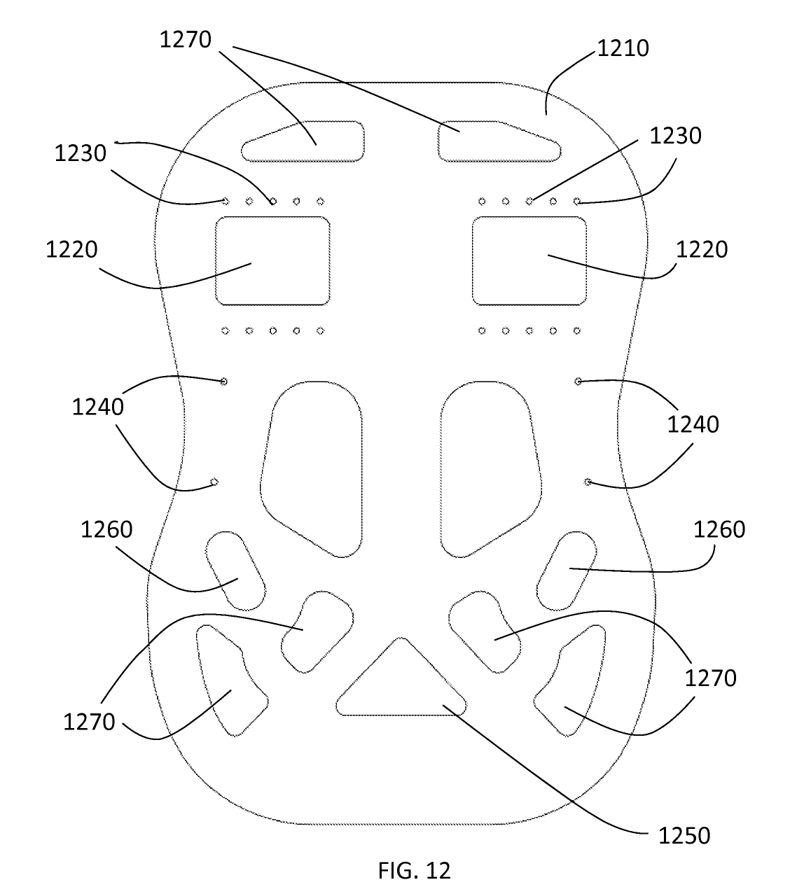

An alternate embodiment for a back plate in accordance with the present invention is shown in FIG. 12. The plate has a rigid body 1210 having two large holes 1220 near the top to allow clearance for the hooks 500 and therefore minimize the thickness of the assembled device. Holes 1230 are provided to attach the half pins 600 to the back plate. The lower half of the alternate back plate includes holes 1240 and spacing for an elastic bungee cord 910 or other elastic strap to be attached to the plate and can be fitted, for example, with a slender bent-rod hook 920. When assembles, the bungee cord passes through openings 1260 and is secured to the back plate through holes 1240 by securing or attaching means such as a bolt/nut, a screw, or stud. The triangular holes 1250 in the plate 300 is provided so that the user can store the lower hook 920 on the interior of the bag when carrying the assembly on-person. The alternate back plate additionally has a variety of vent holes 1270 for providing comfort when the backpack is carried.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. An apparatus comprising:
a plate assembly comprising:
a rigid plate comprising a rigid material having a first opening for receiving an upper hook and a second opening for receiving a lower hook;
a pad having a back surface attached to said rigid plate and a front surface facing away from said rigid plate, said pad having openings corresponding to said first and second openings in said rigid plate;
an upper hook assembly mounted to said rigid plate, said upper hook assembly comprising an upper hook and a pin, wherein said pin is mounted to said rigid plate and said upper hook is rotatably mounted on said pin to have a first position in which said hook projects from said front surface of said pad and a second position in which said hook does not project from said front surface of said pad; and
a lower hook assembly comprising an elastic member connected to said rigid plate and a lower hook connected to said elastic member.

2. An apparatus according to claim 1 further comprising:
a backpack connected said plate assembly, wherein said rigid plate is positioned between said pad and said backpack.

3. An apparatus according to claim 1 wherein said rigid plate further comprises a plurality of vent openings.

4. An apparatus according to claim 1 wherein said rigid plate further comprises:
first and second openings through which said elastic member passes; and
a plurality of holes for attaching said elastic member to said rigid plate.

5. An apparatus according to claim 4 wherein said pad further comprises:
first and second openings through which said elastic member passes

6. An apparatus according to claim 1 further comprising:
a second upper hook assembly mounted to said rigid plate, said second upper hook assembly comprising a second upper hook and a second pin, wherein said second pin is mounted to said rigid plate and said second upper hook is rotatably mounted on said second pin to have a first position in which said second hook projects from said front surface of said pad and a second position in which said second hook does not project from said front surface of said pad.

7. An apparatus according to claim 1 wherein said pin comprises a back plate attachment member attached to said back plate and a rod member on which said upper hook is rotatably mounted.

8. An apparatus according to claim 7 wherein said rod member is welded to said back plate attachment member.

9. An apparatus according to claim 1 wherein said pin comprises a plate portion having a plurality of holes for receiving bolts and a rod portion.

10. An apparatus according to claim 1 wherein said pad is glue to said rigid plate.

11. An apparatus comprising:
a plate assembly comprising:
a rigid plate comprising a rigid material having a first opening for receiving an upper hook;
a pad having a back surface attached to said rigid plate and a front surface facing away from said rigid plate, said pad having openings corresponding to said first and second openings in said rigid plate;
an upper hook assembly mounted to said rigid plate, said upper hook assembly comprising an upper hook and a pair of half pins, wherein each said half pin is mounted to said rigid plate and said upper hook is rotatably mounted on said pair of half pins to have a first position in which said hook projects from said front surface of said pad and a second position in which said hook does not project from said front surface of said pad; and
a lower hook assembly comprising an elastic member connected to said rigid plate and a lower hook connected to said elastic member.
